(19) United States
(12) Patent Application Publication
(10) Pub. No.: US 2012/0283345 A1
(43) Pub. Date: Nov. 8, 2012

(54) HEAT-RESISTANT AND FLAME-RETARDANT EXTRUDED FOAM MADE OF STYRENE COPOLYMERS

(75) Inventors: Holger Ruckdäschel, St. Martin (DE); Ingo Bellin, Mannheim (DE); Christian Däschlein, Mannheim (DE); Klaus Hahn, Kirchheim (DE); Peter Merkel, Zellertal (DE); Juan-Manuel Igea-Ruiz, Tuleda (Navarra) (ES); Herbert Schall, Romerberg (DE); Maria-Kristin Sommer, Wachenheim (DE); Tobias Höld, Mannheim (DE); Christoph Hahn, Neustadt (DE); Elmar Boy, Neustadt (DE)

(73) Assignee: BASF SE, Ludwigshafen (DE)

(21) Appl. No.: 13/464,026

(22) Filed: May 4, 2012

Related U.S. Application Data
(60) Provisional application No. 61/482,622, filed on May 5, 2011.

(51) Int. Cl. C08L 25/12; C08K 3/22; C08K 5/3475; C08J 9/14

(52) U.S. Cl. 521/81; 521/139

(57) ABSTRACT

The invention is directed to extruded foam based on thermoplastic polymers. The foam contains at least one styrene copolymer which contains copolymerized maleic anhydride units or copolymerized maleimide units, and optionally styrene-acrylonitrile copolymers (SAN), and thermoplastic polymers and at least one halogen-containing polymer as flame retardant, and at least one flame retardant synergist selected from antimony trioxide and dicumyl. The invention also relates to a process for producing the foam with introducing carbon dioxide as blowing agent, and acetone as coblowing agent; into the polymer melt in order to form a foamable melt, and extruding the foamable melt into a region of relatively low pressure with foaming to give the extruded foam. The invention also relates to the use of said foam as insulation material and as structural foam.

The invention relates to a heat-resistant and flame-retardant extruded foam based on thermoplastic polymers P, comprising styrene-maleic anhydride copolymers (SMA), styrene-phenylmaleimide copolymers (SPMI), or styrene-acrylonitrile-maleic anhydride terpolymers (SANMA). The invention further relates to a process for producing the extruded foam, and also to use thereof as insulating material and as structural foam.

Polystyrene-based extruded foams are widely used in the construction industry for insulating parts of buildings, such as foundations, walls, floors, and roofs. This application requires extruded foams which have minimum thermal conductivity and thus have high insulation capability. In order to achieve good insulation properties, it is preferable to use closed-cell extruded foams, since these have markedly better insulation capability than open-cell extruded foams.

Extruded foams used in the construction industry are expected to have not only good insulation properties but also good heat resistance, with low density. The heat resistance is very important especially for applications where the foams have exposure to high temperatures, since otherwise the extruded foams can deform and thus impair the insulation. Examples of components where good heat resistance is significant are roof insulation and wall insulation where these have direct exposure to insolation.

Extruded foams should have not only good insulation properties and good heat resistance but also good resistance to solvents, especially to mineral oil and other types of oil. This is a particular requirement for components which are used in the lower parts of walls, in foundations, and in floors.

NL-C 1 005 985 relates to a polymer foam which has fine and homogeneous cell structure and which comprises, as essential component, a styrene copolymer having from 18 to 35 mol % content of monomer units of an anhydride or of its imide, for example styrene-maleic anhydride copolymers, and which is foamed with water as blowing agent.

EP-A 1 479 717 discloses a process for producing foam sheets based on styrene-acrylonitrile copolymers, where these have improved solvent resistance. Water is used as blowing agent or blowing agent component and it is optionally in a combination with CO₂ and/or with other organic blowing agents. The foam sheets obtainable by said process have good solvent resistance. However, there remains room for improvement in relation to heat resistance and insulation properties.

WO 2011/026979 describes a closed-cell extruded foam obtainable via extrusion of one or more styrene-acrylonitrile copolymers with carbon dioxide as blowing agent and one or more coblowing agents selected from the group consisting of C₁-C₄-alcohols and C₁-C₄-carbonyl compounds.

WO 2008/069865 describes styrene-acrylonitrile copolymer foams which comprise one or more infrared-absorbing additives and which have high dimensional stability at relatively high temperatures.

JP-A 2007-238926 describes thermoplastic foams with high heat resistance which, for flame retardancy, have been equipped with brominated flame retardants which exhibit a loss of 5% in weight at temperatures above 270° C. in thermogravimetric analysis.

It was an object of the present invention to provide an extruded foam which exhibits not only flame retardancy but also good insulation properties, good solvent resistance, and good heat resistance. The extruded foam should in particular be suitable for the thermal insulation of single-shell roofs covered with bitumen sheeting.

Accordingly, an extruded foam based on thermoplastic polymers P has been found, comprising

P1) from 50 to 100 parts by weight, preferably from 55 to 75 parts by weight, of one or more styrene copolymers which comprise copolymerized maleic anhydride units or copolymerized maleimide units, and which have, based on P1, from 65 to 90% by weight styrene content,

P2) from 0 to 50 parts by weight, preferably from 30 to 45 parts by weight, of one or more styrene-acrylonitrile copolymers (SAN) having, based on P2, from 65 to 90% by weight styrene content,

P3) from 0 to 15 parts by weight, preferably from 0 to 10 parts by weight, of one or more thermoplastic polymers from the group consisting of styrene polymers other than P1 and P2, polyacrylates, polycarbonates, polyesters, polyamides, polyether sulfones, polyether ketones, and polyether sulfides,

where the entirety of polymer components (P1), (P2) and (P3) of the thermoplastic polymers P gives 100 parts by weight,

F1) from 5 to 15 parts by weight, preferably from 7 to 10 parts by weight, based on P, of at least one halogen-containing polymer as flame retardant,

F2) from 0.5 to 4 parts by weight, preferably from 1 to 3 parts by weight, based on P, of at least one flame retardant synergist selected from antimony trioxide and dicumyl,

Z) from 0 to 10 parts by weight, preferably from 0.1 to 5 parts by weight, based on P, of further additives.

The invention further provides the process described for producing the extruded foam of the invention, and also the use of said foam as insulation material and as structural foam.

The cell number of the extruded foam of the invention is in the range from 1 to 30 cells per mm, preferably from 3 to 20 cells per mm, in particular from 3 to 25 cells per mm.

The density of the extruded foam of the invention is preferably in the range from 20 to 150 kg/m³, particularly preferably in the range from 20 to 60 kg/m³.

The compressive strength of the extruded foam of the invention, measured to DIN EN 826, is generally in the range from 0.15 to 6 N/mm², preferably in the range from 0.3 to 1 N/mm².

The extruded foam of the invention is preferably a closed-cell foam, i.e. the proportion of closed cells to DIN ISO 4590 is at least 90%, in particular from 95 to 100%.

The extruded foam of the invention is flame retardant and complies by way of example with the requirements of standardized fire tests to DIN 4102 B2, European classification (Class E), and—if the constitution and/or time in intermediate inventory after production are appropriate—to DIN 4102 B1.

The following materials used as polymer component P in the invention can be produced by processes known to the person skilled in the art, for example via free-radical anionic or cationic polymerization in bulk, solution, dispersion, or emulsion: styrene copolymers (P1) which comprise copolymerized maleic anhydride units or copolymerized maleimide units, styrene-acrylonitrile copolymer (SAN) (P2), and the thermoplastic polymers (P3). In the case of SAN and SMA, preference is given to production via free-radical polymerization.

It is preferable that the glass transition temperature Tg of the polymers P1, and also of mixtures with the thermoplastic polymers P, is 120° C. or higher, preferably in the range from 125 to 210° C., measured by means of DSC to DIN 53765 (ISO 11357-2) at a heating rate of 20 K/min. The glass transition temperature can be determined by differential scanning calorimetry (DSC) at a heating rate of 20 K/min.

The extruded foam of the invention comprises, as component (P1), from 50 to 100 parts by weight, preferably from 55 to 75 parts by weight, of one or more styrene copolymers which comprise copolymerized maleic anhydride units or copolymerized maleimide units, and which have, based on P1, from 65 to 90% by weight styrene content.

Component (P1) is composed of one or more styrene copolymers which comprise copolymerized maleic anhydride units or copolymerized maleimide units. It is preferable that P1 is composed of from 10 to 45% by weight, with preference from 15 to 30% by weight, of copolymerized maleic anhydride or maleimides, and from 65 to 90% by weight, with preference from 70 to 85% by weight, of copolymerized vinylaromatic monomer, in particular styrene. Preferred maleimides are maleimide itself, N-alkyl-substituted maleimides (preferably using C₁-C₆-alkyl) and N-phenyl-substituted maleimides.

Particular preference is given to the following as component (P1): styrene-maleic anhydride copolymers (SMA), styrene-phenylmaleimide copolymers (SPMI), styrene-maleic anhydride-phenylmaleimide terpolymers (SMAPMI), styrene-acrylonitrile-maleic anhydride terpolymers (SANMA), and mixtures thereof.

The extruded foam of the invention comprises, as component (P2), from 0 to 50 parts by weight, preferably from 30 to 45 parts by weight, of one or more styrene-acrylonitrile copolymers (SAN) having, based on (P2), from 65 to 90% by weight styrene content.

If SAN component (P2) is present it generally comprises from 18 to 40% by weight, preferably from 25 to 35% by weight, and in particular from 30 to 35% by weight, of copolymerized acrylonitrile, and generally comprises from 60 to 82% by weight, preferably from 65 to 75% by weight, and particularly preferably from 65 to 70% by weight, of copolymerized styrene (based in each case on SAN).

The SAN (P2) can optionally comprise from 0 to 22% by weight of at least one copolymerized monomer from the group consisting of alkyl (meth)acrylates, (meth)acrylic acid, maleic anhydride, and maleimides. In one preferred embodiment, the SAN is composed exclusively of styrene and acrylonitrile.

The melt volume rate MVR (220° C./10 kg) to ISO 1133 of the SAN (P2) used in the invention is generally in the range of more than 5 cm³/10 min, preferably more than 20 cm³/10 min, and particularly preferably more than 50 cm³/10 min.

Examples of suitable types of SAN are Luran® 3380, Luran® 33100, Luran® 2580, Luran® 2560 and Luran® VLN from Styrolution GmbH.

It is preferable to use medium- and low-viscosity types of the polymers (P1) and (P2). Intrinsic viscosity measured to DIN 53737 is preferably in the range from 40 to 80 ml/g (measured in 0.5% by weight solution in dimethylformamide at 23° C.).

The extruded foam of the invention comprises, as component (P3), from 0 to 15 parts by weight, preferably from 0 to 10 parts by weight, of one or more thermoplastic polymers from the group consisting of styrene polymers other than (P1) and (P2), polyacrylates, polycarbonates, polyesters, polyamides, polyether sulfones, polyether ketones, and polyether sulfides.

The following are optionally used as thermoplastic polymers (P3) of polymer component P: styrene polymers and styrene copolymers, for example acrylonitrile-butadiene-styrene (ABS), acrylonitrile-styrene-acrylate (ASA), and styrene-methacrylic acid; polyolefins, such as polypropylene (PP), polyethylene (PE), and polybutadiene; polyacrylates, such as polymethyl methacrylate (PMMA); polycarbonates (PC); polyesters, such as polyethylene terephthalate (PET) and polybutylene terephthalate (PBT); polyamides, such as nylon-6, nylon-6,6, nylon-6,l, and nylon-6/6,6; polyether sulfones (PES); polyether ketones (PEK); polyether sulfides (PES), and mixtures thereof.

In one preferred embodiment, the extruded foam of the invention is composed exclusively of polymer components (P1) and (P2), and comprises no (0% by weight of) thermoplastic polymer P3.

One or more flame retardants is/are added in order to comply with the flame retardancy regulations in the construction industry and in other sectors. The extruded foam in the invention also comprises from 5 to 15 parts by weight, preferably from 7 to 10 parts by weight, based on 100 parts by weight of P, of at least one halogen-containing polymer, as flame retardant (F1). The average molecular weight of the halogen-containing polymer used as flame retardant is preferably in the range from 5000 to 300 000, in particular from 20 000 to 150 000, determined by means of gel permeation chromatography (GPC).

The halogenated polymer exhibits a loss in weight of at most 5% by weight in thermogravimetric analysis (TGA) up to a temperature of 250° C., preferably at a temperature up to 270° C., and particularly preferably up to a temperature of 370° C.

The bromine content of preferred halogenated polymers is in the range from 0 to 80 percent by weight, preferably from 10 to 75 percent by weight, and the chlorine content of these is in the range from 0 to 50 percent by weight, preferably from 1 to 25 percent by weight, based on the halogenated polymer.

Preferred halogenated polymers as flame retardants are brominated polystyrene and styrene-butadiene block copolymer having from 40 to 80% by weight bromine content.

Other halogenated polymers preferred as flame retardants are polymers which have tetrabromobisphenol A units (TBBPA), for example tetrabromobisphenol A diglycidyl ether compounds (CAS number 68928-70-1 or 135229-48-0).

The extruded foam of the invention preferably comprises, as flame retardant (F1), brominated polystyrene oligomers or, respectively, polymers, or an oligomer or polymer which has tetrabromobisphenol A units, for example tetrabromobisphenol A diallyl ether.

In the invention, the extruded foam also comprises, as flame retardant synergist (F2), from 0.5 to 4 parts by weight, preferably from 1.5 to 3 parts by weight, based on 100 parts by weight of P, of antimony trioxide or dicumyl, or a mixture thereof.

The extruded foam can also comprise further flame retardants and flame retardant synergists, for example expandable graphite, red phosphorus, triphenyl phosphate, and 9,10-dihydro-9-oxa-10-phosphaphenanthrene 10-oxide. An example of another suitable flame retardant is hexabromocyclododecane (HBCD), in particular the technical products which in essence comprise the α-, β- and γ-isomer and preferably an addition of dicumyl (2,3-dimethyl-2,3-diphenylbutane) as synergist.

The extruded foam can also, if desired, comprise from 0 to 10 parts by weight, based on 100 parts by weight of P, of further additives (Z), such as nucleating agents, fillers (for example mineral fillers, such as glass fibers), plasticizers, IR absorbers, such as carbon black or graphite, aluminum powder, and titanium dioxide, soluble and insoluble dyes, and also pigments. It is preferable to add graphite and carbon black in amounts which are generally from 0.05 to 25% by weight, particularly preferred amounts being from 2 to 8% by weight, based on P. Suitable particle sizes for the graphite are in the range from 1 to 50 μm, preferably in the range from 2 to 10 μm.

The use of UV stabilizers has proven to be an essential aspect for ensuring that product properties remain constant. Specifically in the case of SMA, high levels of UV irradiation lead to visible yellowing and to a chemical change in the material, this change being attended by significant embrittlement. A decisive factor for the selection of suitable UV stabilizers is reactivity with SMA. While stabilizers based on benzotriazoles, such as Tinuvin 234, can improve UV resistance without alteration of processing properties and foam properties, stabilizers based on sterically hindered amines, e.g. Uvinul 4050 and Tinuvin 770, are less suitable for the substance system of the invention. Addition of sterically hindered amines can lead to a reaction with SMA at elevated temperatures with elimination of gaseous reaction products.

The extruded foam preferably comprises, as additive (Z), a UV stabilizer based on benzotriazoles, in amounts in the range from 0.05 to 5 parts by weight, preferably from 0.1 to 1 part by weight, based on 100 parts by weight of polymer P.

Nucleating agents that can be used are fine-particle, inorganic solids, such as talc powder, metal oxides, silicates, or polyethylene waxes, in amounts which are generally from 0.1 to 10 parts by weight, preferably from 1 to 3 parts by weight, based on P. The average particle diameter of the nucleating agent is generally in the range from 0.01 to 100 μm, preferably from 1 to 60 μm. Talc powder is a particularly preferred nucleating agent.

Addition of IR absorbers, such as graphite, carbon black, aluminum powder, titanium dioxide, indoaniline dyes, oxonol dyes, or anthraquinone dyes, is a particularly suitable measure for improving thermal insulation.

Preferred plasticizers are fatty acid esters, fatty acid amides, and phthalates, the amounts that can be used of which are from 0.05 to 10 parts by weight, based on polymer component P.

The invention further provides a process for producing the extruded foam of the invention, comprising the following stages:

(a) production of a polymer melt made of thermoplastic polymers P comprising
P1) from 50 to 100 parts by weight, preferably from 55 to 75 parts by weight, of one or more styrene copolymers which comprise copolymerized maleic anhydride units or copolymerized maleimide units, and which have, based on P1, from 65 to 90% by weight styrene content,
P2) from 0 to 50 parts by weight, preferably from 30 to 45 parts by weight, of one or more styrene-acrylonitrile copolymers (SAN) having, based on P2, from 65 to 90% by weight styrene content,
P3) from 0 to 15 parts by weight, preferably from 0 to 10 parts by weight, of one or more thermoplastic polymers from the group consisting of styrene polymers other than (P1) and (P2), polyacrylates, polycarbonates, polyesters, polyamides, polyether sulfones, polyether ketones, and polyether sulfides,
where the entirety of polymer components (P1), (P2) and (P3) of the thermoplastic polymers P gives 100 parts by weight,
F1) from 5 to 15 parts by weight, preferably from 7 to 10 parts by weight, based on P, of at least one halogen-containing polymer as flame retardant,
F2) from 0.5 to 4 parts by weight, preferably from 1 to 3 parts by weight, based on P, of at least one flame retardant synergist selected from antimony trioxide and dicumyl,
Z) from 0 to 10 parts by weight, preferably from 0.1 to 5 parts by weight, based on P, of further additives,

(b) introduction of
T1) from 1 to 5 parts by weight, based on P, of carbon dioxide as blowing agent,
T2) from 1 to 5 parts by weight, based on P, of acetone as coblowing agent,
T3) from 0 to 1 part by weight, based on P, of one or more coblowing agents selected from the group consisting of C₁-C₄ alkanes into the polymer melt in order to form a foamable melt,

(c) extrusion of the foamable melt into a region of relatively low pressure with foaming to give the extruded foam.

It is preferable that the polymer melt is composed exclusively of components (P1) and (P2) in relation to the thermoplastic polymers P.

The chemical structure places restrictions on the thermal stability. High melt temperatures and long residence times therefore lead to degradation of the material.

In stage (a) of the process, polymer component P is heated in order to obtain a polymer melt. For the purposes of the invention, formation of a polymer melt means plastification of polymer component P in the wider sense, i.e. the conversion of the solid constituents of polymer component P to a deformable or flowable state. For this it is necessary to heat polymer component P to a temperature above the melting point or glass transition temperature. Suitable temperatures are generally at least 150° C., preferably from 160 to 290° C., particularly preferably from 220 to 260° C.

The temperature of the polymer melt should be minimized, preferably to below 260° C. At higher temperatures, the following effects occur: (i) Uncontrolled elimination of CO₂ can occur via reaction of styrene-maleic anhydride copolymer (SMA), making it difficult to establish precise amounts of blowing agent. (ii) Mixtures of styrene-acrylonitrile copolymers (SAN) and styrene-maleic anhydride copolymer (SMA) can lead to crosslinking effects at elevated temperatures.

The heating of polymer component P (stage (a) of the process of the invention) can be achieved by means of any desired equipment known in the technical sector, for example by means of an extruder or of a mixer (e.g. a kneader). It is preferable to use primary extruders. Stage (a) of the process of the invention can be carried out continuously or batchwise, but preference is given to a continuous procedure here.

In stage (a), components (F1), (F2), and optionally further additions (Z) are added in the amounts as described above to the polymer melt. Addition after stage (a), or addition in mixtures with the blowing agent components, is also possible.

Stage (b) of the process of the invention comprises, in order to form a foamable melt, the introduction of a blowing agent component T into the polymer melt produced in stage (a).

The selection of suitable blowing agents and blowing agent compositions is a decisive factor during sheet production and for the properties of the foamed materials. The use of carbon dioxide as sole blowing agent leads to severe nucleation and to rapid escape from the foam structure, because of the high diffusion rate of carbon dioxide and restricted solubilities at the comparatively high processing temperatures. Many blowing agents have proven unsuccessful for the polymers P used in the invention in conjunction with flame retardants. Among these are specifically:
(i) Aliphatic and aromatic alcohols, where these undergo esterification leading to ring-opening of the maleic anhydride, and thus markedly reduce compressive strengths and heat resistances.
(ii) Dimethyl ether, which in combination with brominated flame retardants can lead to formation of carcinogenic organic species.
(iii) Various halogenated blowing agents have now been banned as a result of requirements associated with climate change.

The invention therefore also uses, as blowing agent (T1), from 1 to 5 parts by weight, preferably from 2.5 to 4.5 parts by weight, based on 100 parts by weight of P, of carbon dioxide as blowing agent.

From 1 to 5 parts by weight, preferably from 1 to 3 parts by weight, based on 100 parts by weight of P, of acetone are also added as coblowing agent (T2).

From 0 to 1 part by weight, preferably from 0.1 to 1.0 part by weight, based on 100 parts by weight of P, of one or more coblowing agents selected from the group consisting of C₁-C₄ alkanes can be added as further coblowing agent (T3). Isobutane is particularly preferred as coblowing agent (T3).

Particularly at high sheet thicknesses, the blowing agents and coblowing agents used in the invention lead to improved surfaces and improved dimensional stability. The presence of acetone and, respectively, alkanes can give a higher level of plastification during melt processing and calibration.

The blowing agents and coblowing agents (T1), (T2), and (T3) can comprise water. Water passes into blowing agent component T primarily via the use of technical-grade chemicals.

In one preferred embodiment, the blowing agents are in essence anhydrous. Particular preference is given to mixtures of carbon dioxide and acetone, and also to mixtures of carbon dioxide, acetone, and isobutane. The water content of the polymer melt after stage b) is preferably at most 1% by weight, particularly preferably less than 0.1% by weight.

The total proportion of blowing agent component T added to the polymer melt is from 1 to 12% by weight, preferably from 1 to 8% by weight, and with particular preference 1.5 to 7% by weight (based in each case on P).

The blowing agents (T1), (T2), and (T3) can be incorporated into molten polymer component P via any method known to the person skilled in the art. By way of example, extruders or mixers (e.g. kneaders) are suitable. In one preferred embodiment, the blowing agent is mixed under elevated pressure with molten polymer component P. The pressure here must be sufficiently high for substantial prevention of foaming of the molten polymer material, and for homogeneous dispersion of blowing agent component T in molten polymer component P. Suitable pressures are from 50 to 500 bar (absolute), preferably from 100 to 300 bar (absolute), particularly preferably from 150 to 250 bar (absolute). The temperature in stage (b) of the process of the invention has to be selected in such a way that the polymeric material is molten. To this end, it is necessary that polymer component P is heated to a temperature above the melting point or glass transition temperature. Suitable temperatures are generally at least 150° C., preferably from 160 to 290° C., particularly preferably from 220 to 260° C. Stage (b) can be carried out continuously or batchwise, but it is preferable to carry out stage (b) continuously.

The blowing agents can be added in the primary extruder or in a downstream stage. It is preferable to add the blowing agents directly in the primary extruder.

In one preferred embodiment, the foamable polymer melt is passed through XPS extruders known to the person skilled in the art, for example by way of a tandem structure made of primary extruder and secondary extruder. Continuous and batch methods can be used for the process, where polymer component P is melted in the primary extruder (stage (a)), and the blowing agent is added (stage (b)) to form a foamable melt, likewise in the primary extruder. The process of incorporation by mixing and dissolution of the blowing agent can also be achieved by way of static mixing units after stage (a), for example via static mixers.

Stage (c) of the process of the invention comprises the foaming of the foamable melt in order to obtain an extruded foam. To this end, the foamable melt provided with blowing agent is cooled in the secondary extruder to a temperature suitable for the foaming process. The cooling of the melt can also be achieved to some extent or completely via static melt coolers, for example static heat exchangers (available by way of example from Fluitec or Sulzer).

To this end, the melt is conveyed through a suitable apparatus, for example a slot die. The slot die is heated at least to the temperature of the polymer melt comprising blowing agent. It is preferable that the temperature of the die is from 60 to 230° C. It is particularly preferable that the temperature of the die is from 110 to 170° C.

The polymer melt comprising blowing agent is transferred through the die into a region where the pressure prevailing is lower than in the region in which the foamable melt is kept before extrusion through the die. The lower pressure can be superatmospheric or subatmospheric. Preference is given to extrusion into a region at atmospheric pressure.

Stage (c) is likewise carried out at a temperature at which the material to be foamed is present in the molten state, generally at temperatures of from 80 to 170° C., particularly preferably at from 110 to 160° C. Because, in stage (c), the polymer melt comprising blowing agent is transferred into a region in which the prevailing pressure is relatively low, the blowing agent is converted to the gaseous state. The polymer melt expands and foams as a consequence of the large rise in volume.

The pressure selected at the die has to be sufficiently high to prevent premature foaming in the die, and suitable pressures for this purpose are at least 50 bar, preferably from 60 to 180 bar, particularly preferably from 80 to 140 bar.

The geometric shape of the cross section of the extruded foams obtainable by the process of the invention is determined in essence via the selection of the die plate and optionally via suitable downstream equipment, such as sheet calibrators, roller-conveyor take-offs, or belt take-offs, and is freely selectable.

When the composition of the invention is used in respect of materials and of blowing agents, the quality of the surface depends on the temperature of the surface of the calibrator. Surface temperatures below 50° C. lead to severe cooling of the surface of the foam and consequently to longitudinal and transverse cracking, and also to thickness differences between the edge and middle of the sheet. It is therefore preferable to use calibrators which can be heated via external sources, e.g. oil-based or electrical temperature-control systems. Surface temperatures are preferably more than 50° C., particularly preferably more than 100° C. Preference is also given to the use of release-effect surfaces, for example Teflon-coated metals, or metals covered with Teflon foils.

The extruded foams obtainable by the process of the invention preferably have a rectangular cross section. The thickness of the extruded foams here is determined via the height of the die-plate slot. The thickness is from 20 to 300 mm, preferably from 20 to 200 mm. The width of the extruded foams is determined via the width of the die-plate slot. The length of the extruded foam parts is determined in a downstream operation via familiar processes known to the person skilled in the art, examples being adhesive bonding, welding, sawing, and cutting. Particular preference is given to extruded foam parts with geometry in the shape of a sheet. “In the shape of a sheet” means that the thickness (height) dimension is small in comparison with the width dimension and the length dimension of the molding.

It is also possible to apply foil coatings to the material after the calibration process, in order to improve the UV resistance of the material, to increase the quality of the surface, and to reduce the temperature of the surface. The foils preferably comprise UV stabilizers and/or light absorbers and/or reflectors and/or flame retardants at a concentration higher than that in the foamed material.

The invention also provides the use of the extruded foams of the invention, and of the moldings obtainable therefrom. Preference is given to the use as insulation material in particular in the construction industry, below ground and above ground, for example for foundations, walls, floors, and roofs. Preference is likewise given to the use as structural foam, in particular for lightweight construction applications, and as core material for composite applications.

The extruded foam of the invention has good insulation properties and good solvent resistance, and in particular has good heat resistance. Preference is given to the use as insulation material in particular in the construction industry, below ground and above ground, for example for foundations, walls, floors, and specifically roofs. The foam therefore combines three important properties in a single material, and said material can therefore be used universally in a very wide variety of applications which hitherto required the use of various materials specifically adapted for each use. The extruded foam of the invention can be used advantageously for thermal insulation of roofs, where this is necessary not only during installation (contact with hot bitumen) but also during the lifetime of the roof (elevated usage temperature due to covering with high-absorbency bitumen sheeting). Other possible applications are the insulation of tanks for storing hot water, and the use for lightweight construction applications, for example as core material for sandwich applications.

The extruded foam of the invention is obtainable without the use of blowing agents which are problematic from an environmental point of view, or which are problematic in respect of fire-protection regulations. Furthermore, although density is lower than in extruded foams of the prior art, it provides good insulation properties and mechanical properties at the same time as high solvent resistance and high heat resistance, which is generally at least 20° C. above that of conventional extruded polystyrene foam (XPS). By way of example, the dimensional stability value without mechanical load is at least 100° C. (maximum permissible dimensional change <3%).

### EXAMPLES

### Raw Materials Used

Luran® 2580 SAN having 25% by weight acrylonitrile content and having an intrinsic viscosity of about 80 ml/g (product commercially available from Styrolution)
Luran® VLN: SAN having 25% acrylonitrile content and having an intrinsic viscosity of about 65 ml/g (product commercially available from Styrolution)
Xiran® SZ 26080 Styrene-maleic anhydride copolymer (SMA) having 26% by weight maleic acid content and having an intrinsic viscosity of 80 ml/g (product commercially available from Polyscope)
SANMA Styrene-acrylonitrile-maleic anhydride terpolymer from BASF having 24% by weight acrylonitrile content and 2.1% by weight maleic acid content
Graphite Kropfmühl, UF 99.5
ATO Antimontrioxid Ultrafine, Campine
TBBPA F-2400, p-TBBPA, from ICL
Tinuvin® 234 2-(2H-benzotriazol-2-yl)-4,6-bis(1-methyl-1-phenylethyl)phenol, UV stabilizer from BASF SE

### General Operating Specification

The foam sheets of the invention were produced in a tandem extrusion system. The copolymers used were introduced continuously together with flame retardant and additives into a primary extruder. The flame retardants were masterbatches. The blowing agents (CO₂, ethanol, acetone, isobutane) were introduced continuously through an injection aperture introduced within the primary extruder (ZSK 120). Total throughput inclusive of the blowing agents was 750 kg/h. The melt comprising blowing agent was cooled in a downstream secondary extruder (ZE 400) and extruded through a slot die. The foaming melt was drawn off by way of a roller conveyor through a heated calibrator, the surfaces of which had been equipped with Teflon, and was molded to give sheets. Typically sheet dimensions before mechanical operations were about 700 mm width and 50 mm thickness.

### Examples 1-11

In each of examples 1-11, 10 parts of p-TBBPA as flame retardant, 1.5 parts of antimony trioxide as flame retardant synergist, and 0.2 part by weight of Tinuvin® 234 were added in addition to 100 parts by weight of polymer. Example 5 used 2.5 parts of antimony trioxide instead of 1.5 parts. In example 10, 1.0 part by weight of graphite UF 99.5 was also added as IR absorber to 100 parts by weight of polymer.

Carbon dioxide as blowing agent (T1) and acetone as coblowing agent (T2) were also respectively added to every 100 parts by weight of polymers in examples 1-10, and the parts by weight can be found in the table. Carbon dioxide as blowing agent (T1), acetone as coblowing agent (T2), and isobutane as coblowing agent (T3) were also respectively added to every 100 parts by weight of polymers in example 11, and the parts by weight can be found in the table.

Table 1 collates polymer composition, process parameters, and properties of the extruded foam sheets.

TABLE 1

| | Example | | | | | | | | | | |
|---|---|---|---|---|---|---|---|---|---|---|---|
| | B1 | B2 | B3 | B4 | B5 | B6 | B7 | B8 | B9 | B10 | B11 |
| Luran ® 2580 | 40 | | | 30 | 40 | 40 | 40 | | 40 | | |
| Luran ® VLN | | 40 | 40 | | | | | | | 40 | 40 |
| Xiran ® SZ 26080 | 60 | 60 | 60 | 70 | 60 | 60 | 60 | 60 | 55 | 60 | 60 |
| SANMA | | | | | | | | 40 | 5 | | |
| Carbon dioxide | 3.5 | 3.5 | 3.5 | 3.5 | 3.5 | 3.5 | 3.5 | 3.5 | 3.5 | 3.5 | 3.5 |
| Acetone | 3.0 | 3.0 | 2.5 | 3.0 | 3.0 | 2.0 | 3.5 | 3.0 | 3.0 | 3.0 | 2.6 |
| Isobutane | | | | | | | | | | | 0.4 |
| Process temperature after | 243 | 233 | 237 | 244 | 243 | 246 | 240 | 236 | 240 | 233 | 235 |
| primary extruder | | | | | | | | | | | |
| Die pressure (bar) | 105 | 102 | 106 | 113 | 107 | 112 | 101 | 105 | 108 | 108 | 110 |
| Calibrator temperature (° C.) | 135 | 135 | 135 | 135 | 135 | 135 | 135 | 135 | 135 | 135 | 135 |
| Foam density (g/l) | 37 | 36 | 36 | 38 | 43 | 39 | 37 | 36 | 36 | 37 | 35 |
| Sheet thickness (mm) | 50 | 50 | 50 | 50 | 50 | 50 | 45 | 50 | 50 | 50 | 50 |
| Heat resistance² | <105 | <105 | <105 | <110 | <105 | <110 | <105 | <105 | <105 | <105 | <105 |
| Glass transition temperature of | 130 | 129 | 129 | 135 | 130 | 130 | 130 | 132 | 128 | 129 | 129 |
| polymer/flame retardant | | | | | | | | | | | |
| mixture (° C.)¹ | | | | | | | | | | | |
| Heat resistance ≧100° C.² | yes | yes | yes | yes | yes | yes | yes | yes | yes | yes | yes |
| Fire-resistant to DIN 4102 B2 | yes | yes | yes | yes | yes | yes | yes | yes | yes | yes | yes |
| Classification for flame | yes | yes | yes | yes | yes | yes | yes | yes | yes | yes | yes |
| retardancy as polymer | | | | | | | | | | | |
| UV resistance³ | yes | yes | yes | yes | yes | yes | yes | yes | yes | yes | yes |
| Stability during covering with | yes | yes | yes | yes | yes | yes | yes | yes | yes | yes | yes |
| bitumen⁴ | | | | | | | | | | | |
| Surface cracking⁵ | no | no | no | no | no | no | no | no | no | no | no |
| Crosslinking⁶ | no | no | no | no | no | no | no | no | no | no | no |
| Undesired degradation | no | no | no | no | no | no | no | no | no | no | no |
| products⁷ | | | | | | | | | | | |
| Reaction with blowing agent⁸ | no | no | no | no | no | no | no | no | no | no | no |
| Dimensional compliance⁹ | yes | yes | yes | yes | yes | yes | yes | yes | yes | yes | yes |
| Gas vacuoles¹⁰ | no | no | no | no | no | no | no | no | no | no | no |
| Corrosion/degradation¹¹ | no | no | no | no | no | no | no | no | no | no | no |

¹Glass transition temperature of polymer mixture measured by means of DSC to DIN 53765 (ISO 11357-2) at a heating rate of 20 K/min
²Maximum permissible linear dimensional change of 3%, analyzed in all three sheet directions (longitudinal, transverse, vertical in relation to direction of extrusion) during isothermal heat-aging for at least 6 h (analysis of sheet materials of thickness 50 mm one week after production)
³Determination of UV resistance via yellowing index, determined on compacted undiluted material; maximum permissible increase in E1330 yellowness index: 15% after 1000 h of irradiation (exposure to light outdoors)
⁴Resistance to dimensional change/partial melting on application of molten bitumen at a temperature of 185° C.; failure criterion is either formation of gas bubbles in the bitumen or irreversible deformation of the sheet by more than 2 mm
⁵Visual assessment of surface cracking on surface of sheet
⁶Crosslinked products detected via dissolution of final product in THF and detection of constituents which have low solubility or are insoluble
⁷Undesired degradation products, detected via trace analysis by means of GC-MS
⁸Reaction with blowing agent, detected via IR spectroscopy by means of comparison with initial spectrum
⁹Dimensional compliance within the required specifications (subdivision of the sheet area used into central region and edge regions on each respective side; average thickness in each of the regions is not permitted to deviate from the specified dimension by more than ±2.5%)
¹⁰Visual assessment of vacuoles larger than 10 mm² on cross section of sheet
¹¹Corrosion/degradation due to corrosive attack on screws, barrel, and flange; substantial attack requires replacement of the units after less than 6 months

1-14. (canceled)

15. An extruded foam based on thermoplastic polymers P comprising
P1) from 50 to 100 parts by weight of one or more styrene copolymers which comprise copolymerized maleic anhydride units or copolymerized maleimide units, and which have, based on P1, from 65 to 90% by weight styrene content,
P2) from 0 to 50 parts by weight of one or more styrene-acrylonitrile copolymers (SAN) having, based on P2, from 65 to 90% by weight styrene content,
P3) from 0 to 15 parts by weight of one or more thermoplastic polymers from the group consisting of styrene polymers other than P1 and P2, polyacrylates, polycarbonates, polyesters, polyamides, polyether sulfones, polyether ketones, and polyether sulfides,
where the entirety of polymer components (P1), (P2) and (P3) of the thermoplastic polymers P does not exceed 100 parts by weight,
F1) from 5 to 15 parts by weight, based on P, of at least one halogen-containing polymer as flame retardant,
F2) from 0.5 to 4 parts by weight, based on P, of at least one flame retardant synergist selected from antimony trioxide and dicumyl,
Z) from 0 to 10 parts by weight, based on P, of further additives.

16. The extruded foam according to claim 15, wherein the glass transition temperature Tg of the thermoplastic polymers P is 120° C. or higher, measured by means of DSC to DIN 53765 at a heating rate of 20 K/min.

17. The extruded foam according to claim 15, which comprises, as flame retardant F1, a polymer which has tetrabromobisphenol A units.

18. The extruded foam according to claim 15, which comprises a UV stabilizer as additive.

19. The extruded foam according to claim 15, the density of which is in the range from 20 to 150 kg/m³, and the cell number of which is in the range from 1 to 30 cells/mm.

20. A process for producing an extruded foam comprising the following stages:
(a) producing a polymer melt made of thermoplastic polymers P comprising
P1) from 50 to 100 parts by weight of one or more styrene copolymers which comprise copolymerized maleic anhydride units or copolymerized maleimide units, and which have, based on P1, from 65 to 90% by weight styrene content,
P2) from 0 to 50 parts by weight of one or more styrene-acrylonitrile copolymers (SAN) having, based on P2, from 65 to 90% by weight styrene content,
P3) from 0 to 15 parts by weight of one or more thermoplastic polymers from the group consisting of styrene polymers other than P1 and P2, polyacrylates, polycarbonates, polyesters, polyamides, polyether sulfones, polyether ketones, and polyether sulfides,
where the entirety of polymer components (P1), (P2) and (P3) of the thermoplastic polymers P gives 100 parts by weight,
F1) from 5 to 15 parts by weight, based on P, of at least one halogen-containing polymer as flame retardant,
F2) from 0.5 to 4 parts by weight, based on P, of at least one flame retardant synergist selected from antimony trioxide and dicumyl,
Z) from 0 to 10 parts by weight, based on P, of further additives,
(b) introducing
T1) from 1 to 5 parts by weight, based on P, of carbon dioxide as blowing agent,
T2) from 1 to 5 parts by weight, based on P, of acetone as coblowing agent,
T3) from 0 to 1 part by weight, based on P, of one or more coblowing agents selected from the group consisting of C₁-C₄ alkanes
into the polymer melt in order to form a foamable melt,
(c) extruding the foamable melt into a region of relatively low pressure with foaming to give the extruded foam.

21. The process according to claim 20, wherein the polymer melt is maintained at a temperature in the range from 235 to 265° C. in stages a) and b).

22. The process according to claim 20, wherein the polymer melt is maintained at a pressure in the range from 80 to 140 bar before the foaming process in stage c).

23. The process according to claim 20, wherein the foamable melt is extruded at a temperature in the range from 120 to 140° C. through a slot die in stage c).

24. The process according to claim 20, wherein the polymer melt made of thermoplastic polymers P is composed exclusively of components P1 and P2.

25. The process according to claim 20, wherein the water content of the polymer melt after stage b) is at most 1% by weight.

26. The process according to claim 20, wherein, in stage b),
T1) from 2.5 to 4.5 parts by weight of carbon dioxide and
T2) from 1.0 to 3.0 parts by weight of acetone are introduced.

27. The process according to claim 26, wherein, in stage b),
T1) from 2.5 to 4.5 parts by weight of carbon dioxide
T2) from 1.0 to 3.0 parts by weight of acetone, and
T3) from 0.1 to 1.0 part by weight of isobutane are introduced.

28. An insulation material or structural foam comprising the extruded foam according to claim 15.
